(19) United States
(12) Patent Application Publication
(10) Pub. No.: US 2002/0125316 A1
(43) Pub. Date: Sep. 12, 2002

(54) Multi-track linear card reader apparatus and method

(76) Inventors: Robert R. Rogers, Newport Beach, CA (US); Gerhard Rotter, Mission Viejo, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/060,030

(22) Filed: Jan. 28, 2002

Related U.S. Application Data
(60) Provisional application No. 60/264,482, filed on Jan. 26, 2001.

(51) Int. Cl. G06K 7/00

(52) U.S. Cl. 235/440

(57) ABSTRACT

The apparatus includes a suitable enclosure or case, housing a tray or holder to receive and hold a high-memory card which may be formed of a recordable medium, or alternatively has inserted therein or placed thereon a magnetic or optical recordable medium on which data is recorded in the form of linear magnetic or optical recorded tracks. The card is held in place by card positioning pins and positioning springs. A linear head array can be caused to scan the card by a head array scanning motor driving a head array transportation wire. To precisely position the card with reference to the track positions or to move the card from one track of a track group to the next, the card tray may be moved orthogonaly stepped at right angles to the direction of travel of the linear head array assembly by a drive motor operating a lead screw and card tray leadscrew interface.

This application claims the benefit of U.S. Provisional Application No. 60/264,482 filed Jan. 26, 2001 entitled “Multi-Track Linear Card Reader Apparatus and Method,” the entire content of which is hereby expressly incorporated by reference.

### FIELD OF THE INVENTION

This invention related to read-write apparatus and methods for high density data recording on recording media in the shape of a card and particularly to an apparatus and method for recording and reading multiple linear tracks.

### BACKGROUND OF THE INVENTION

Cards the size of a credit card or business cards supporting a layer of magnetizable medium offer a convenient and highly portable data storage device. However, this non-circular configuration has presented a substantial obstacle for high density data recording and storage.

### SUMMARY OF THE INVENTION

The preferred embodiment of this invention provides a card read and write apparatus for high density recording on a multiplicity of linear recording tracks. These tracks are recorded on high density magnetic or optical recording media placed in or on the card. The high-memory card is positioned adjacent to a linear array of read/write heads, or a multi-channel read/write head, and the head array is moved linearly relative to a card axis.

### BRIEF DESCRIPTION OF THE DRAWINGS

FIG. 1 is a top plan view of a card reader constructed in accordance with a preferred embodiment of this invention; and

FIG. 2 is a top plan view of an alternative embodiment of the invention.

### DETAILED DESCRIPTION OF THE PREFERRED EMBODIMENT

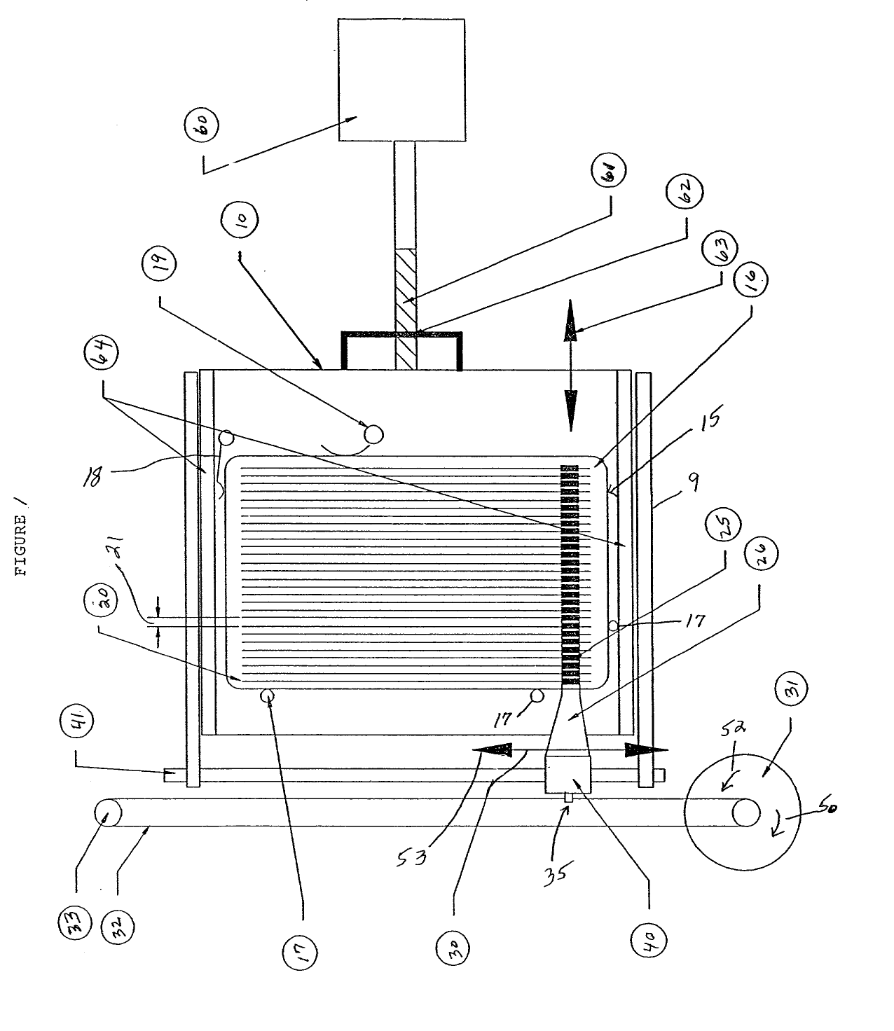

A preferred embodiment of the linear read/write head array apparatus of the present invention is illustrated in FIG. 1. Housing 9 supports a tray or holder 10 for linear movement. Tray 10 receives and holds a high-memory card 15. Card 15 may be composed of a magnetic or optical storage media or alternatively of a nonmagnetic material such as plastic or ceramic supporting a layer of suitable recording magnetic or optical medium. In certain applications, it may be advantageous to support both magnetic and optical recordable mediums on the card.

In the embodiment shown, one surface 16 is composed substantially entirely of a magnetizable medium. Alternatively, both the top and bottom faces of the card 15 may comprise a recording medium or card 15 may have inserted therein or placed thereon a magnetizable medium. Data is recorded on this magnetizable medium in the form of a plurality of parallel linear tracks 20 spaced at a track pitch 21.

The card 15 is held in place on tray 10 by card positioning pins 17 and positioning springs 18, 19. These springs are located in juxtaposition, respectively, with two adjacent sides of the card 15 to bias the card against the pins 17.

A linear head array 25 is located on a head array holder 26. In the embodiment of FIG. 1, the array 25 includes a head for each track or track group. Alternatively, a multi-channel read/write head having a channel for each track or track group may be used. Array 25 is caused to scan the card 15 in the direction of travel 30 by scanning motor 31 driving a head array transportation loop wire 31. Wire 32 is supported in place and rotates around roller 33 to align an extended length of the wire 32 parallel to the tracks 20. As shown at 35, wire 32 is attached to head array holder guide bushing 40. This bushing 40 is supported for linear motion on guide rod 41. Head array holder 26 is attached to head array guide bushing 40. As a result, rotation of motor 31 in a clockwise direction 50 translates head array 25 from left to right (arrow 51). Counterclockwise rotation 52 of motor 31 translates head array 25 from right to left (arrow 53).

In order to achieve high density recording and reading of the multiple tracks 20, the embodiment shown in FIG. 1 advantageously includes a mechanism for precisely positioning the pre-recorded tracks 20 with respect to the read/write head array 25. Motor 60 drives a lead screw 61 in engagement with leadscrew interface 62. Interface 62 is coupled to tray 10 guided by ball slide assembly 64 to translate the card 15 in the direction shown by arrow 63 which is orthogonal to the direction of travel of the head array 25. A servo control responsive to the output of one or more of the heads of array 25 can advantageously be used to control motor 60 to precisely position the head array 25.

Each head of head array 25 scans a separate one of each of tracks 20. Data stored in the multiple tracks 20 can thus be written or read simultaneously from all of the recording channels as the head array is translated by motor 31 in the direction of arrow 30.

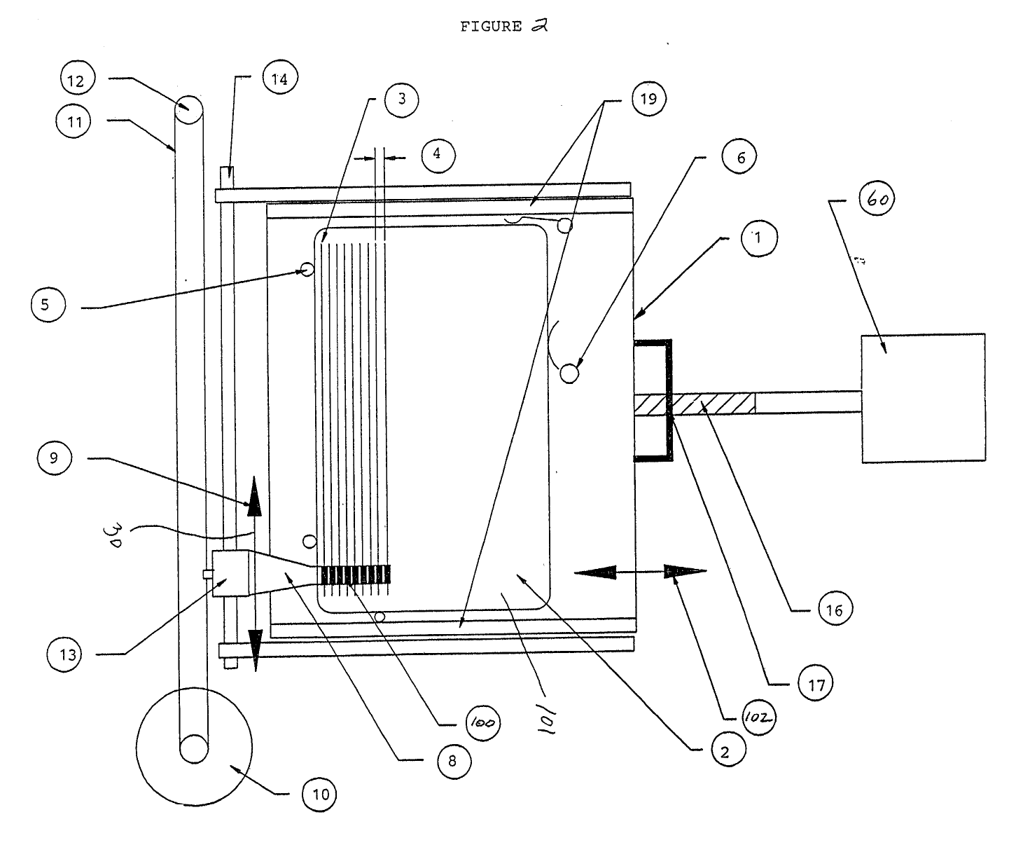

FIG. 2 illustrates another embodiment of the invention wherein the head array 100 simultaneously reads and/or writes a series of tracks which occupy a lesser area of the card 101. In the high-memory embodiment shown, somewhat more than half the area of the card 101 is not occupied by a magnetic recording medium leaving the balance of the card surface free to hold, for example, a conventional magnetic card strip, or one or more integrated circuit chips, thus allowing the card to function as a hybrid card.

Alternatively, the card 101 may have an area of magnetization substantially as large as the card area with more tracks recorded than there are heads in array 100. In this alternative embodiment, the card is translated by motor 60 to shift the card and its magnetic medium underneath the head array in the direction of arrow 102 to read/write a plurality of tracks greater than the tracks shown in FIG. 2. For example, the motor 60 may provide segmented scans so that before a new scan is initiated, the card is translated laterally in the direction of arrow 102 a distance equal to a group of multiple tracks so as to thereby shift the card to the next segment or group of multiple tracks. As a result, each head, on demand, is used to sweep more than one recording track.

While the embodiments described above provide multiple linear recording tracks 20 along the long axis of the high-memory card 15, another embodiment (not shown) constructed in accordance with this invention provides a series of linear read-write tracks along the short axis of the card 15.

Further, although the embodiments described above shuttle the read/write head assembly across the high-memory card, other embodiments (not shown) fix the head in place and move the tray and card 10 past the head array along the axis 30 parallel to the track. In still other embodiments, both the head array and card are moved to produce the plurality of substantially linear tracks.

While the invention has been described herein with reference to certain preferred embodiments, these embodiments have been presented by way of example only, and not to limit the scope of the invention. Accordingly, other embodiments and changes in form and detail may be made therein by one skilled in the art without departing from the spirit and scope of the invention, including embodiments which do not provide all of the benefits and features set forth herein.

What is claimed is:

1. A high density card reader apparatus comprising
a housing,
a tray supported by said housing,
a thin high density recording card approximately the size of a credit or business card,
positioning pins and springs on said tray to bias the recording card against said pins,
a lead screw driven by said motor for linearly driving said card supporting tray along a first axis,
a linear multiple head array in juxtaposition with a recording surface of said recording card,
a head array actuator apparatus attached to said linear multiple recording head array to linearly translate said array across the surface of said card along a second axis substantially octagonal to said first axis,
each head of said linear multiple head array scanning a separate one of each of a plurality of linear recorded tracks of said recording card, and
said lead screw drive precisely positioning said tracks with respect to said head array.

2. A high density card reader apparatus comprising
a housing,
a tray supported by said housing,
a thin high density recording card,
card retainer apparatus supported by said tray,
a linear translation apparatus coupled to said tray,
a linear multiple head array in juxtaposition with a recording surface of said recording card,
a head array actuator apparatus attached to said linear multiple recording head array to linearly translate said array across the surface of said card,
each head of said linear multiple head array scanning at least one track of a plurality of recorded track of said recording card.

3. The card reader apparatus of claim 2, wherein said card is approximately the size of a credit or business card.

4. The card reader apparatus of claim 2, wherein said card retainer apparatus includes one or more projections above the surface of said tray.

5. The card reader apparatus of claim 4, wherein said card retainer apparatus includes springs to bias the card against said projections.

6. The card reader apparatus of claim 2, including an actuator for incrementally moving said head linearly across the surface of said card.

7. The card reader apparatus of claim 2, wherein said linear translation apparatus includes an electro-mechanical actuator.

8. The card reader apparatus of claim 7, wherein said linear translation apparatus includes a motor driving a lead screw.

9. The card reader apparatus of claim 2, wherein said head array actuator apparatus includes a movable wire attached to said head array and parallel to said tracks.

10. The card reader apparatus of claim 2, wherein said recorded tracks occupy substantially the area of said card.

11. The card reader apparatus of claim 2, wherein said recorded tracks occupy substantially less than the area of said card.

12. The card reader apparatus of claim 11, wherein the area of said card without said tracks support other recording media such as a magnetic stripe.

13. The card reader apparatus of claim 11, wherein the area of said card without said tracks support one or more integrated circuit chips.

14. The card reader apparatus of claim 2, wherein said plurality of tracks are greater than the number of heads in said multiple head array.

15. The card reader apparatus of claim 14, wherein said linear translation apparatus coupled to said tray moves the card so that different tracks are read by said multiple head array.

16. A high density card reader apparatus comprising:
a housing,
a tray supported by said housing,
a thin high density recording card approximately the size of a credit or business card,
positioning pins and springs on said tray to bias the recording card against said pins,
a linear multiple head array in juxtaposition with a recording surface of said recording card,
a head array actuator apparatus attached to said linear multiple recording head array to linearly translate said arrow across the surface of said card along a second axis substantially octagonal to said first axis,
said heads of said linear multiple head array respectively scanning plural tracks of said recording card,
a plurality of recording tracks on said recording card, the number of said tracks exceeding the number of heads in said linear multiple head array,
a lead screw interface attached to said tray,
a motor and a lead screw driven by said motor for linearly driving said card supporter tray with respect to said head array to juxtapose different tracks with said heads so that a head can, on demand, sweep more the one track.

17. A method for recording and/or reading a recordable medium provided by a rectangular high-memory card similar in size to a credit card comprising:
placing said card in an assembly adjacent to an array of read/write heads;
moving said array of read/write heads with respect to said high-memory card so that said head records or reads a plurality of substantially linear recording tracks.

18. The method of claim 17, wherein said tracks are substantially located along the longer axis of said high-memory card.

19. The method of claim 17, wherein said tracks are substantially located along the shorter axis of said high-memory card.

20. The method of claim 17, comprising:
moving said card along an axis substantially orthogonal to the axis of said recording tracks.

21. The method of claim 17, wherein the number of said read/write heads is substantially equal to the number of said recording tracks.

22. The method of claim 17, wherein the number of said read/write heads is less than the number of recording tracks, said method comprising:
sweeping one or more of said heads over more than one of said recording tracks.

23. The method of claim 17, comprising:
moving said card relative to said head array to sweep one or more of said heads over more than one of said recording tracks.
